(19) United States
(12) Patent Application Publication
(10) Pub. No.: US 2025/0274385 A1
(43) Pub. Date: Aug. 28, 2025

(54) SYSTEMS AND METHOS FOR CREATING TUNNELS FOR ROUTING IN A CLOUD COMPUTING SYSTEM

(71) Applicant: Verizon Patent and Licensing Inc., Basking Ridge, NJ (US)

(72) Inventors: Christopher PAINTER, Inver Grove Heights, MN (US); Dhaval V. KHAROD, Montgomery Village, MD (US)

(73) Assignee: Verizon Patent and Licensing Inc., Basking Ridge, NJ (US)

(21) Appl. No.: 18/590,701

(22) Filed: Feb. 28, 2024

(51) Int. Cl. H04L 45/42; H04L 12/46; H04L 45/03; H04L 45/50

(52) U.S. Cl. CPC H04L 45/42; H04L 12/4633; H04L 45/03; H04L 45/50

(57) ABSTRACT

In some implementations, a routing device may indicate, to a direct connect gateway in a cloud computing system, a default route, wherein the default route is propagated to a virtual network function (VNF) running in the cloud computing system. The routing device may create a generic routing encapsulation (GRE) tunnel between the VNF and the routing device based on the default route, wherein the GRE tunnel permits a direct peering between the VNF and a private network outside of the cloud computing system. The routing device may perform a routing between the VNF and the private network using the GRE tunnel.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of an example associated with a cloud platform prior to migration to a cloud computing system.

FIG. 2 is a diagram of an example associated with a design issue associated with a migration of a cloud platform to a cloud computing system.

FIG. 3 is a diagram of an example associated with a design issue associated with a migration of a cloud platform to a cloud computing system.

FIG. 4 is a diagram of an example associated with creating tunnels for routing in a cloud computing system.

FIG. 5 is a diagram of an example associated with creating tunnels for routing in a cloud computing system.

FIG. 6 is a diagram of an example environment in which systems and/or methods described herein may be implemented.

FIG. 7 is a diagram of example components of one or more devices of FIG. 6.

FIG. 8 is a flowchart of an example process associated with creating tunnels for routing in a cloud computing system.

### DETAILED DESCRIPTION OF EXAMPLE EMBODIMENTS

The following detailed description of example implementations refers to the accompanying drawings. The same reference numbers in different drawings may identify the same or similar elements.

A private cloud platform hosting virtual network functions (VNFs) may be migrated to a cloud computing system to obtain the various benefits associated with the cloud computing system (e.g., improved overall network performance and/or user experience). The cloud computing system may be available to individuals, companies, or governments. The cloud computing system may provide various services related to networking, computing, and/or storage.

The VNFs may provide various services, which may all be migrated to the cloud computing system. The VNFs may be associated with firewalls, session border controllers, software-defined wide area networks (SD-WANs), routers, and/or virtual private network (VPN) concentrators. As part of the migration, the VNFs may be created in the cloud computing system. The private cloud platform may be decommissioned after migration of the VNFs to the cloud computing system.

However, migrating the VNFs from the private cloud platform to the cloud computing system may cause various issues. In the private cloud platform, the architecture, connectivity, and/or rules may be fully dictated, whereas in the cloud computing system, native services must be utilized.

One issue with the migration is that the cloud computing system may not be designed for true networking. The cloud computing system may not necessarily be built to route between public networks and private networks. Enterprise customers may have relatively large networks and thereby relatively large routing tables, and these routing tables may need to be advertised into cloud providers. The cloud computing system may limit a number of routes that are allowed. For example, the cloud computing system may only allow 100 routes. A typical enterprise network may have a minimum of 1200 routes, which may far exceed a route limit associated with the cloud computing system.

Another issue with the migration may be associated with dynamic routing updates. A VNF running in the cloud computing system should be able to obtain routing information. For example, a firewall in the cloud computing system should be able to distinguish between a default route to the Internet and a specific route into a private network, and if the firewall were to lose connectivity to the Internet, the firewall should be able to dynamically remove its route. Typically however, the cloud computing system is a static environment that uses static routing. For example, a routing table may statically indicate, for a route, that an application's next hop may be a virtual gateway, and such an approach may not be able to handle dynamic routing functions like route withdrawal or route updates that are required between VNFs and private/public networks.

In some implementations, a routing device, such as a private Internet Protocol (e.g., multi-protocol label switching (MPLS)) provider edge (PE) router, may indicate, to a direct connect gateway in a cloud computing system (e.g., an cloud computing system), a default route. The default route may be propagated to a VNF running in the cloud computing system. The VNF may be a firewall, a session border controller, an SD-WAN, routing, or a VPN concentrator. The routing device may create a generic routing encapsulation (GRE) tunnel between the VNF and the routing device based on the default route. The GRE tunnel may permit a direct peering between the VNF and a private network outside of the cloud computing system. The private network may be an MPLS network. The routing device may perform a routing between the VNF and the private network using the GRE tunnel. An infrastructure in the cloud computing system may be bypassed during the routing, where the infrastructure may include a virtual private gateway, a direct connect gateway, and/or an Internet gateway. A plurality of routes may be advertised to the VNF via a dynamic routing peer within the GRE tunnel. A quantity associated with the plurality of routes may be greater than a routing limit associated with the direct connect gateway based on only the default route being apparent to the cloud computing system. Further, the routing device may add or remove a route to or from a list of advertised routes using a dynamic border gateway protocol (BGP) or another applicable data routing protocol, where the route may be added or removed based on an availability or unavailability of the VNF, respectively.

In some implementations, the default route may be advertised to the direct connect gateway in the cloud computing system. The default route may be propagated to the VNF, which may provide a minimum amount of routing to set up the GRE tunnel. Within the GRE tunnel, a separate routing peering may be set up to the private network, which may allow a direct peering between the VNF (e.g., a function managed on behalf of a customer) and the private network. The direct peering may allow an exchange of traffic between the VNF and the private network. The cloud computing system may be unaware of the direct peering, which may allow the plurality of routes (e.g., 10,000 routes or more) to be stored in the VNF. The cloud computing system may only be aware of routing endpoints of the GRE tunnel.

In some implementations, the routing device may be configured to handle this GRE tunneling, where the routing device may be associated with a network edge. The direct peering to the VNF in the cloud computing system may be enabled based on the GRE tunneling, which may make the infrastructure transparent to the routing device in its routing decision. The routing device may determine a routing destination, and when the routing destination is removed, a corresponding route may be removed using the dynamic BGP. The route may disappear from the private network (e.g., a customer corporate network). For example, when a route to the Internet that is advertised to the private network is lost, the route may be dynamically removed, such that traffic will not be directed to an Internet gateway that is not actively routing to the Internet.

In some implementations, by creating the GRE tunnel for routing between public networks and private networks, the routing may not necessarily be limited by a route limit associated with the cloud computing platform. The GRE tunnel may be created based on the default route to satisfy the route limit, but the GRE tunnel may be used to support a plurality of routes that may exceed the route limit. Further, the GRE tunnel may be used to support dynamic routing (e.g., when a VNF is down), which may prevent routing to VNFs that are not available. As a result, the GRE tunnel for routing may improve an overall network performance.

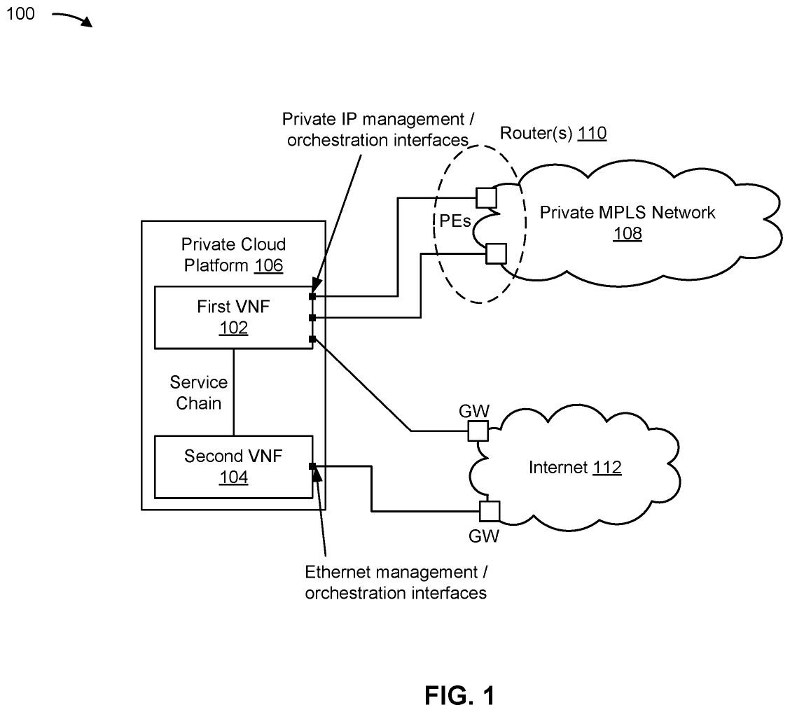

FIG. 1 is a diagram of an example 100 associated with a private cloud platform 106 prior to migration to a cloud computing system.

As shown in FIG. 1, the private cloud platform 106 may include a plurality of VNFs, such as a first VNF 102 and a second VNF 104. The first VNF 102 and the second VNF 104 may be connected via a service chain. The first VNF 102 and the second VNF 104 may be associated with various network interfaces, such as network-to-network interfaces (NNIs). The first VNF 102 may be associated with MPLS management/orchestration interfaces. The second VNF 104 may be associated with Ethernet management/orchestration interfaces. For both the first VNF 102 and the second VNF 104, standard MPLS PE interfaces may be utilized for customer management interfaces. The first VNF 102 may be connected, via an NNI, to a private MPLS network 108 via a router 110. For example, the first VNF 102 may be connected to a MPLS network via a PE router. The second VNF 104 may be connected, via an NNI, to Internet 112 via an Internet gateway (GW) router.

As indicated above, FIG. 1 is provided as an example. Other examples may differ from what is described with regard to FIG. 1.

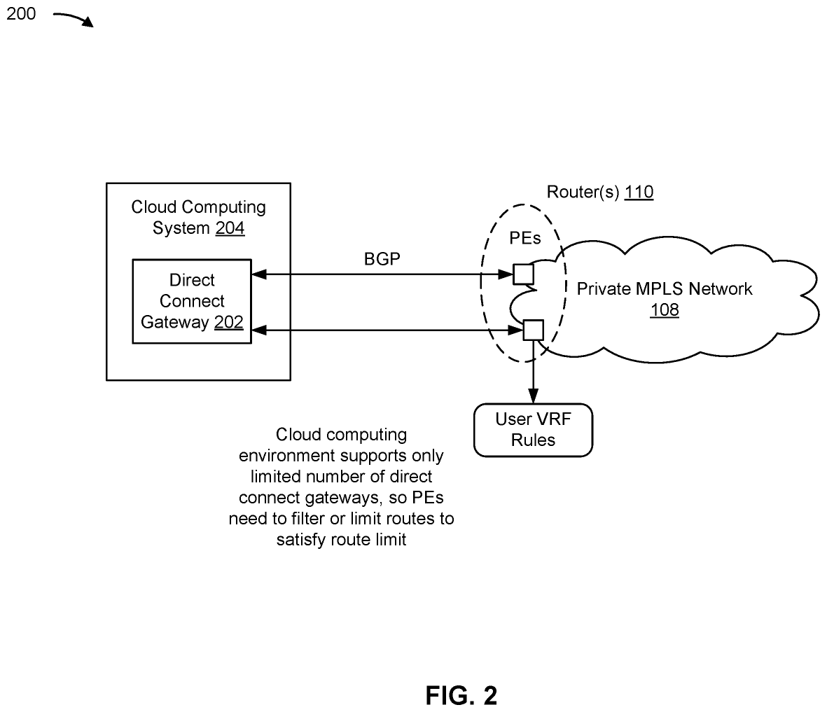

FIG. 2 is a diagram of an example 200 associated with a design issue associated with a migration of a cloud platform to a cloud computing system 204.

As shown in FIG. 2, a direct connect gateway (DXGW) 202 in the cloud computing system 204 may be connected to a router 110 (e.g., a MPLS PE router) associated with a private MPLS network 108 (e.g., a MPLS network). The direct connect gateway 202 may be connected to the router 110 in accordance with a BGP. However, the router 110 to the direct connect gateway 202 may be subject to a routing limit (e.g., 100 maximum routes). The cloud computing system 204 may only support a limited number of routes (e.g., 100 routes) for the direct connect gateway 202 for a given time period. A MPLS PE router may need to filter or limit routes to satisfy a route limit for the cloud computing system 204, which may be in accordance with MPLS customer virtual route forwarding (VRF) routes.

The routing limit may apply to designs that require MPLS underlay routing. The routing limit may apply to VNFs with MPLS connectivity (e.g., besides SD-WAN tunnel connection interfaces). A majority of cloud platform connected MPLS VRFs may have a maximum route above the routing limit. For example, cloud platform customers, prior to migration, may have MPLS VRF route limits as high as 60,000 routes, which is well over the routing limit associated with the cloud computing system.

As indicated above, FIG. 2 is provided as an example. Other examples may differ from what is described with regard to FIG. 2.

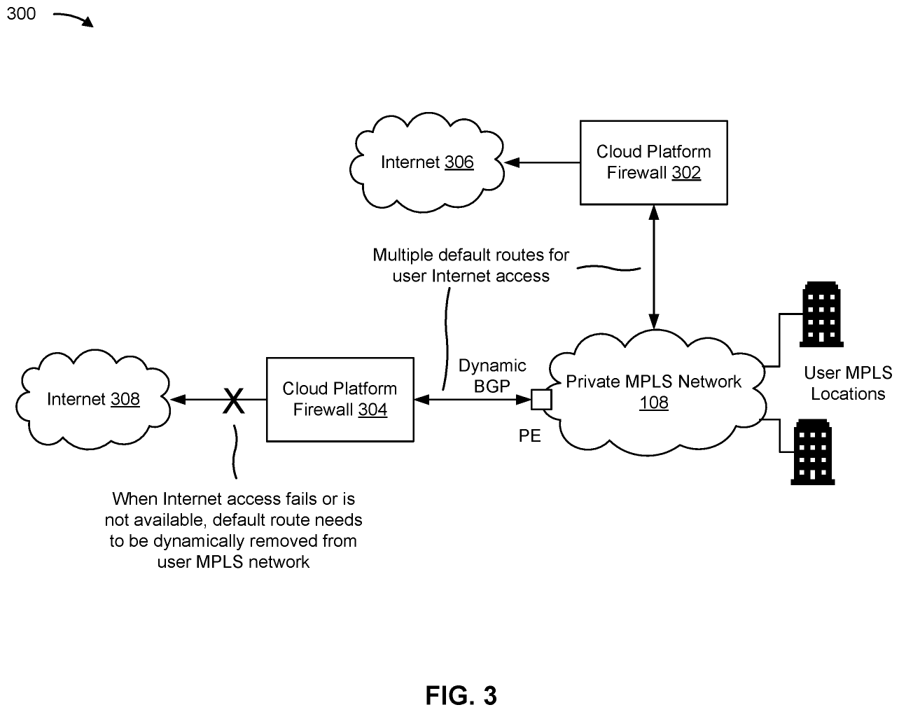

FIG. 3 is a diagram of an example 300 associated with a design issue associated with a migration of a cloud platform to a cloud computing system.

As shown in FIG. 3, dynamic routing failover may occur to another customer cloud site or other customer location. A private MPLS network 108 (e.g., a MPLS network) may be connected to different Internets via firewalls, respectively. For example, the private MPLS network 108 may connect to a first cloud platform firewall 302, which may connect to a first Internet 306, and the private MPLS network 108 may connect to a second cloud platform firewall 304, which may connect to a second Internet 308. Various default routes may be defined for customer Internet access. However, when Internet access fails or is not available (e.g., Internet breakout occurs), a default route may need to be dynamically removed from the private MPLS network 108 (e.g., a customer MPLS network associated with the private MPLS network), which may not be currently possible in the cloud computing system. The dynamic routing failure may apply to service chains with MPLS underlay connectivity or Internet breakout. A majority of virtual network service (VNS) service chains may require dynamic routing based on a customer VNS design. Only a limited number of service chains that fail over at an application level may not require dynamic routing.

As indicated above, FIG. 3 is provided as an example. Other examples may differ from what is described with regard to FIG. 3.

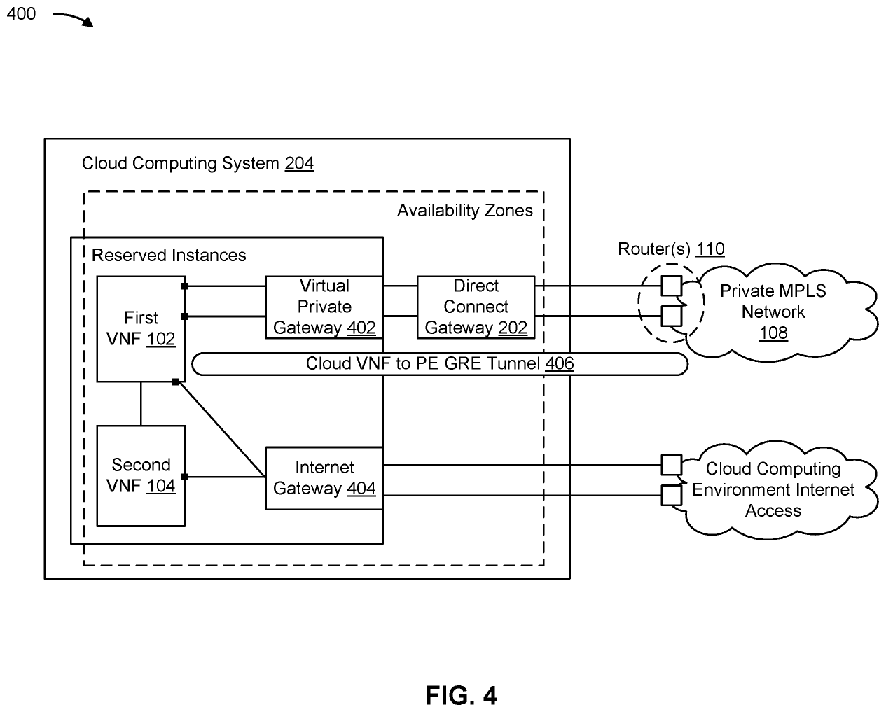

FIG. 4 is a diagram of an example 400 associated with creating tunnels for routing in a cloud computing system 204.

As shown in FIG. 4, a plurality of VNFs, such as a first VNF 102 and a second VNF 104, may run on one or more computing resources (e.g., reserved instances) in the cloud computing system 204. The one or more computing resources may be associated with one or more availability zones. A private MPLS network 108 (e.g., a MPLS network) and cloud computing system Internet access may exist outside of the cloud computing system 204. The first VNF 102 may connect to a virtual private gateway 402. The virtual private gateway 402 may be connected to a direct connect gateway 202. The direct connect gateway 202 may be connected to one or more routers 110 (e.g., MPLS PE routers) or point of presences (POPs) associated with the private MPLS network 108.

In some implementations, a GRE tunnel 406, such as a cloud VNF to MPLS PE GRE tunnel, may be created between the first VNF 102 and the private MPLS network 108 to overcome various limitations associated with the cloud computing system 204 (e.g., a routing limit associated with the cloud computing system 204). Further, the first VNF 102 and the second VNF 104 may be connected to an Internet gateway 404. The Internet gateway 404 may be connected to the cloud computing system Internet access.

In some implementations, a router 110, such as a MPLS PE router, may indicate a default route to the direct connect gateway 202. The default route may be propagated to the first VNF 102 running in the cloud computing system 204. The first VNF 102 may be a firewall, a session border controller, an SD-WAN, routing, a secure gateway, or a VPN concentrator. The router 110 may create a generic GRE tunnel 406 between the first VNF 102 and the router 110 based on the default route. The GRE tunnel 406 may permit a direct peering between the first VNF 102 and the private MPLS network 108 outside of the cloud computing system 204. The GRE tunnel 406 may allow traffic to be routed directly between the first VNF 102 and the private MPLS network 108, which may allow the traffic to bypass the direct connect gateway 202 and the virtual private gateway 402. The direct connect gateway 202 and/or the virtual private gateway 402 may be subjected to a routing limit, so by bypassing the direct connect gateway 202 and the virtual private gateway 402 and instead allow the traffic to directly flow via the GRE tunnel 406, the routing limit may no longer be applicable.

In some implementations, the router 110 may perform routing between the first VNF 102 and the private MPLS network 108 using the GRE tunnel 406. An infrastructure in the cloud computing system 204 may be transparent during the routing, where the infrastructure may include the virtual private gateway 402, a direct connect gateway 202, and/or an Internet gateway 404. A plurality of routes may be advertised to the first VNF 102 via the GRE tunnel 406. A quantity associated with the plurality of routes may be greater than the routing limit associated with the direct connect gateway 202, which may be due to only the default route being apparent to the cloud computing system 204. Further, the router 110 may add or remove a route to or from a list of advertised routes using a dynamic BGP, where the route may be added or removed based on an availability or unavailability of the first VNF 102, respectively.

In some implementations, the default route may be advertised to the direct connect gateway 202 in the cloud computing system 204. The default route may be propagated to the first VNF 102, which may provide a minimum amount of routing to set up the GRE tunnel 406. Within the GRE tunnel 406, a separate routing peering may be set up to the private MPLS network 108, which may allow a direct peering between the first VNF 102 (e.g., a function managed on behalf of a customer) and the private MPLS network 108. The direct peering may allow an exchange of traffic between the first VNF 102 and the private MPLS network 108. The cloud computing system 204 may be unaware of the direct peering, which may allow the plurality of routes (e.g., 10,000 routes or more) to be stored in the first VNF 102. The cloud computing system 204 may only be aware of routing endpoints of the GRE tunnel 406 and not of the plurality of routes available to the first VNF 102. A number of routes seen by the direct connect gateway 202 may be minimized, and in some cases, may be limited to only the default route.

In some implementations, the router 110 may be configured to handle this GRE tunneling, where the router 110 may be associated with a network edge. The direct peering to the first VNF 102 in the cloud computing system 204 may be enabled based on the GRE tunneling, which may make the infrastructure transparent to the router 110 in its routing decision. The router 110 may determine a routing destination, and when the routing destination is removed, a corresponding route may be removed using an appropriate data routing protocol, such as the dynamic BGP. The route may disappear from the private MPLS network 108 (e.g., a customer corporate network). For example, when a route to the Internet that is advertised to the private MPLS network 108 is lost, the route may be dynamically removed, such that traffic will not be directed to an Internet gateway that is not actively routing to the Internet.

In some implementations, by creating the GRE tunnel 406 for routing between public networks and private networks, the routing may not necessarily be limited by a route limit associated with the cloud computing system 204. The GRE tunnel 406 may be created based on the default route to satisfy the route limit, but the GRE tunnel 406 may be used to support a plurality of routes that may exceed the route limit. Further, the GRE tunnel 406 may be used to support dynamic routing (e.g., when the first VNF 102 is down), which may prevent routing to VNFs that are not available. As a result, the GRE tunnel 406 for routing may improve an overall network performance.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

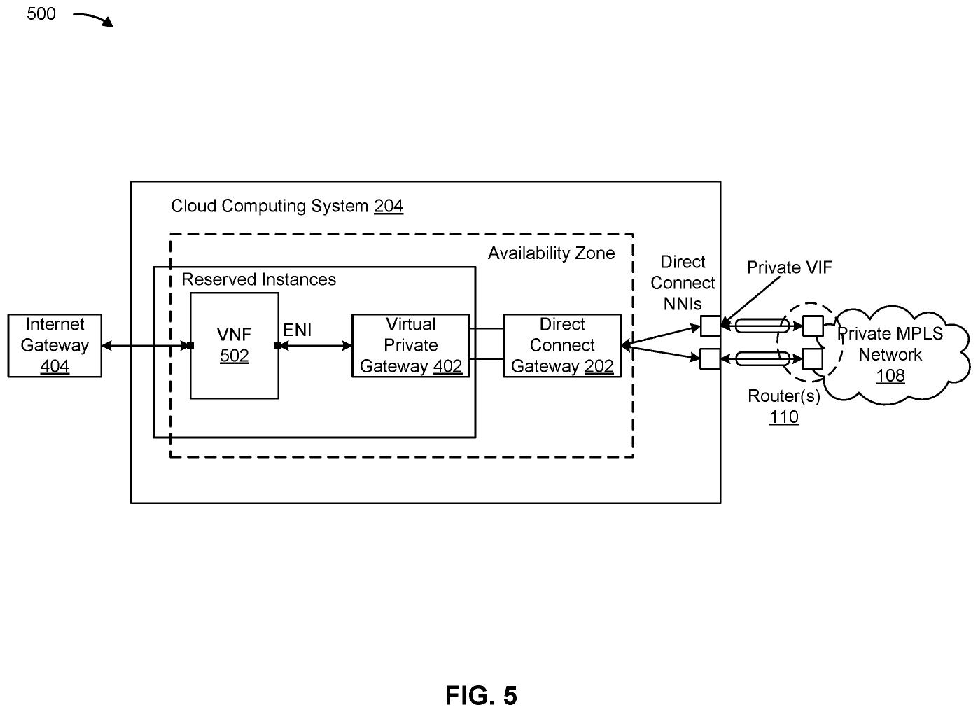

FIG. 5 is a diagram of an example 500 associated with creating tunnels for routing in a cloud computing system 204.

As shown in FIG. 5, a VNF 502 (e.g., a VNF) may run in an availability zone (e.g., a region or local zone) of the cloud computing system 204. The VNF 502 may be connected to a virtual private gateway 402. The virtual private gateway 402 may be connected to a direct connect gateway 202, which may be connected to multiple direct connect NNIs. A direct connect NNI may be connected to a router 110 (e.g., a MPLS PE router) via a private virtual interface (VIF). The router 110 may direct traffic to a private MPLS network 108 (e.g., a MPLS network). Each region or local zone may be connected to MPLS via two diverse MPLS direct connect NNIs. Direct connect diversity may be utilized when possible. PE and direct connect (DX) connection location diversity may vary per location. A customer service chain (single or multiple VNFs) may include one or more of a single virtual private cloud (VPC), private Internet Protocol (IP) classless inter-domain routing (CIDRs), an Internet gateway CIDR, a single direct connect gateway, a single virtual gateway (VGW), a single Internet gateway (IGW), and/or VNF management connectivity.

In some implementations, Internet may utilize the IGW. MPLS may utilize new NNIs to direct connect locations. A direct connect gateway per service chain instance with multiple VIFs may be used. A VGW for connecting a VPC to the direct connect gateway 202 on MPLS may be used. GRE tunneling with BGP between the router 110 and a VNF MPLS interface may be used, as described herein. Only certain MPLS PE routers may be available to be used for GRE tunneling. GRE may not be needed for SD WAN overlay interfaces or management interfaces with a single MPLS customer VRF design.

In some implementations, a region may have multiple availability zones. A local zone may have one availability zone for compute assignment. In some implementations, direct connect locations may correspond to MPLS NNI termination locations. Direct connect locations may be built at an infrastructure level. Direct connect locations may be different than cloud computing system regions or local zones. Direct connect locations may use a network/backbone to connect to regions or local zones. In some implementations, the direct connect gateway 202 may include routing tables (e.g., one per VPC for direct connect to region/local zone VPC). The direct connect gateway 202 may be built in a customer account. The direct connect gateway 202 may route traffic from a direct connect connection to a region or local zone compute location on a cloud computing system core/backbone. The VIF may be assigned to a customer direct connect gateway. The direct connect gateway 202 may be associated with a virtual private gateway that is created in the customer account. In some implementations, a private VIF may correspond to an interface on the direct connect gateway 202, which may include virtual local area networks (VLANs) and BGP peering IP addresses. The private VIF may be built in an infrastructure organization unit level. The private VIF may be one per MPLS VLAN connecting to a customer VNF within the VPC.

In some implementations, the VPC may include computing resources (e.g., instances) and/or customer VNFs. The computing resources and/or the customer VNFs may reside in the VPC. The VPC may be built in the customer account. The VPC may be built in the region or local zone. One or more VPC may be defined per service chain (single or multiple VNFs). The VPC may be associated with the IGW and/or the VGW for Internet and MPLS connectivity, respectively. In some implementations, the VGW (or virtual private gateway) may be built on the customer account. One or more VGWs may be defined per service chain (single or multiple VNFs). The VGW may be assigned to the VPC and/or a gateway associated with a direct connect gateway. The VGW and potentially other entities may be used for MPLS connectivity.

In some implementations, based on a VNF design, one IGW may be defined per service chain (single or multiple VNFs). Service chain designs with multiple Internet ports on the VNF(s) may utilize the same IGW. In some implementations, a computing resource per VNF may be deployed in the VPC. A single VNF solution may require one computing resource, and a dual VNF solution may require two computing resources. In some implementations, CIDR blocks may be used for both Internet and MPLS subnets. Subnets defined within the VPC may be out of VPC assigned CIDR blocks. The VGW assigned to the VPC may propagate allowed CIDR blocks to the direct connect gateway 202, and then to the router 110 via direct connect gateway BGP peers assigned on the private VIFs.

In some implementations, one direct connect gateway 202 and one VGW may be used per VPC. Each router connection (e.g., MPLS PE router connection) may have a corresponding private VIF (MPLS PE router to direct connect gateway). The router 110 may have a unique source ID for its GRE configuration. A GRE source IP on the VNF may be shared when possible, or the GRE source IP may be unique depending on the VNF. Each GRE may have a unique VIF. Each GRE may have a unique MPLS PE interface.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

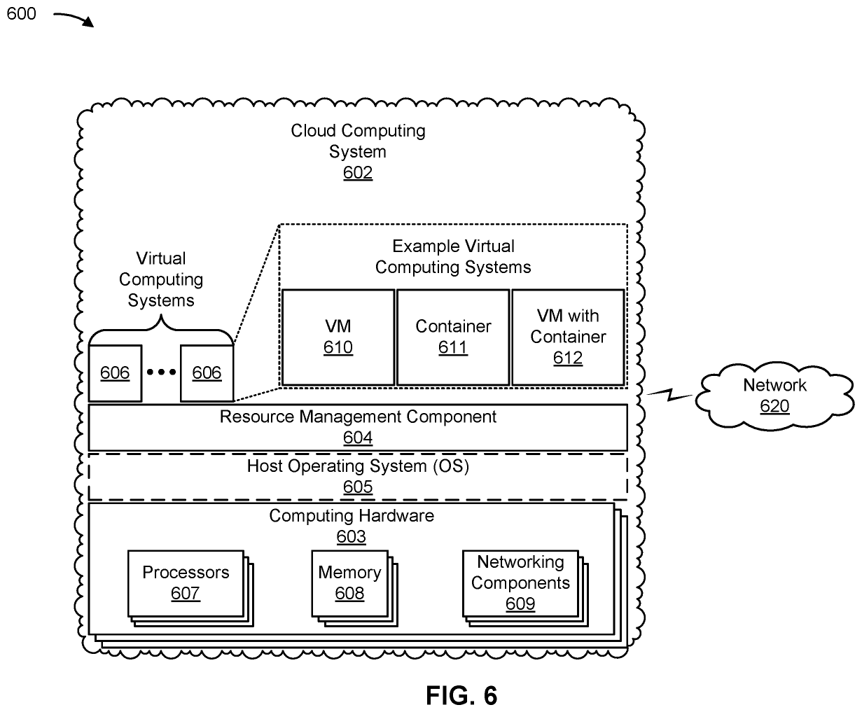

FIG. 6 is a diagram of an example environment 600 in which systems and/or methods described herein may be implemented. As shown in FIG. 6, environment 600 may include one or more elements of and/or may execute within a cloud computing system 602. The cloud computing system 602 may include one or more elements 603-612, as described in more detail below. As further shown in FIG. 6, environment 600 may include a network 620. Devices and/or elements of environment 600 may interconnect via wired connections and/or wireless connections.

The cloud computing system 602 may include computing hardware 603, a resource management component 604, a host operating system (OS) 605, and/or one or more virtual computing systems 606. The cloud computing system 602 may execute on, for example, a platform. The resource management component 604 may perform virtualization (e.g., abstraction) of computing hardware 603 to create the one or more virtual computing systems 606. Using virtualization, the resource management component 604 enables a single computing device (e.g., a computer or a server) to operate like multiple computing devices, such as by creating multiple isolated virtual computing systems 606 from computing hardware 603 of the single computing device. In this way, computing hardware 603 can operate more efficiently, with lower power consumption, higher reliability, higher availability, higher utilization, greater flexibility, and lower cost than using separate computing devices.

The computing hardware 603 may include hardware and corresponding resources from one or more computing devices. For example, computing hardware 603 may include hardware from a single computing device (e.g., a single server) or from multiple computing devices (e.g., multiple servers), such as multiple computing devices in one or more data centers. As shown, computing hardware 603 may include one or more processors 607, one or more memories 608, and/or one or more networking components 609. The one or more networking components 609 may include a routing device (e.g., a MPLS PE router), which may be responsible for creating tunnels for routing in the cloud computing system 602. Examples of a processor, a memory, and a networking component (e.g., a communication component) are described elsewhere herein.

The resource management component 604 may include a virtualization application (e.g., executing on hardware, such as computing hardware 603) capable of virtualizing computing hardware 603 to start, stop, and/or manage one or more virtual computing systems 606. For example, the resource management component 604 may include a hypervisor (e.g., a bare-metal or Type 1 hypervisor, a hosted or Type 2 hypervisor, or another type of hypervisor) or a virtual machine monitor, such as when the virtual computing systems 606 are virtual machines 610. Additionally, or alternatively, the resource management component 604 may include a container manager, such as when the virtual computing systems 606 are containers 611. In some implementations, the resource management component 604 executes within and/or in coordination with a host operating system 605.

A virtual computing system 606 may include a virtual environment that enables cloud-based execution of operations and/or processes described herein using computing hardware 603. As shown, a virtual computing system 606 may include a virtual machine 610, a container 611, or a hybrid environment 612 that includes a virtual machine and a container, among other examples. A virtual computing system 606 may execute one or more applications using a file system that includes binary files, software libraries, and/or other resources required to execute applications on a guest operating system (e.g., within the virtual computing system 606) or the host operating system 605.

The network 620 may include one or more wired and/or wireless networks. For example, the network 620 may include a cellular network, a public land mobile network (PLMN), a local area network (LAN), a wide area network (WAN), a private network, the Internet, an MPLS network, and/or a combination of these or other types of networks. The network 620 enables communication among the devices of the environment 600.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of the environment 600 may perform one or more functions described as being performed by another set of devices of the environment 600.

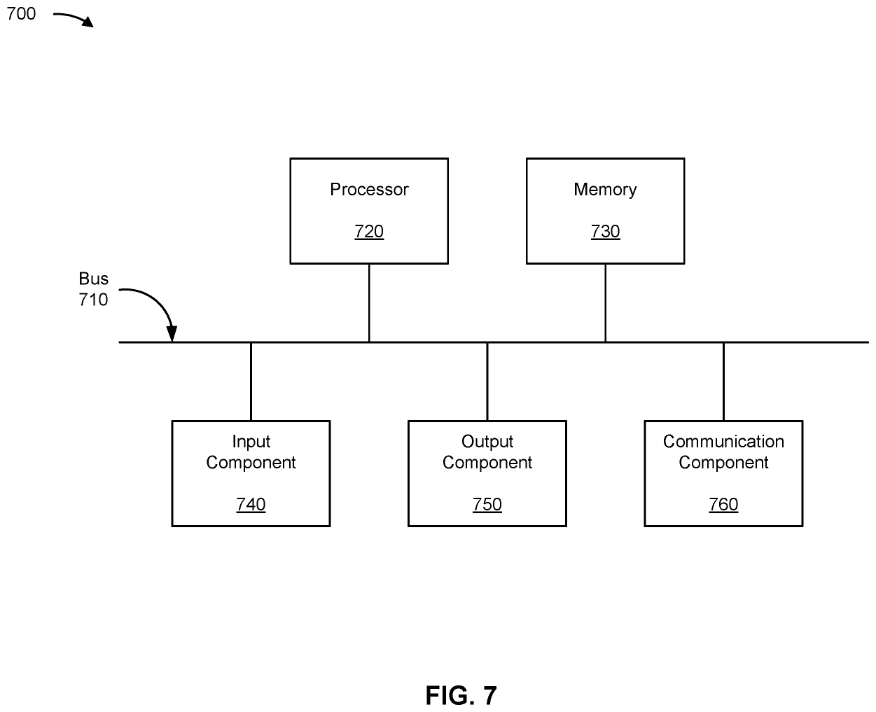

FIG. 7 is a diagram of example components of a device 700 associated with creating tunnels for routing in a cloud computing system. The device 700 may correspond to a routing device (e.g., a MPLS PE router). In some implementations, the routing device may include one or more devices 700 and/or one or more components of the device 700. As shown in FIG. 7, the device 700 may include a bus 710, a processor 720, a memory 730, an input component 740, an output component 750, and/or a communication component 760.

The bus 710 may include one or more components that enable wired and/or wireless communication among the components of the device 700. The bus 710 may couple together two or more components of FIG. 7, such as via operative coupling, communicative coupling, electronic coupling, and/or electric coupling. For example, the bus 710 may include an electrical connection (e.g., a wire, a trace, and/or a lead) and/or a wireless bus. The processor 720 may include a central processing unit, a graphics processing unit, a microprocessor, a controller, a microcontroller, a digital signal processor, a field-programmable gate array, an application-specific integrated circuit, and/or another type of processing component. The processor 720 may be implemented in hardware, firmware, or a combination of hardware and software. In some implementations, the processor 720 may include one or more processors capable of being programmed to perform one or more operations or processes described elsewhere herein.

The memory 730 may include volatile and/or nonvolatile memory. For example, the memory 730 may include random access memory (RAM), read only memory (ROM), a hard disk drive, and/or another type of memory (e.g., a flash memory, a magnetic memory, and/or an optical memory). The memory 730 may include internal memory (e.g., RAM, ROM, or a hard disk drive) and/or removable memory (e.g., removable via a universal serial bus connection). The memory 730 may be a non-transitory computer-readable medium. The memory 730 may store information, one or more instructions, and/or software (e.g., one or more software applications) related to the operation of the device 700. In some implementations, the memory 730 may include one or more memories that are coupled (e.g., communicatively coupled) to one or more processors (e.g., processor 720), such as via the bus 710. Communicative coupling between a processor 720 and a memory 730 may enable the processor 720 to read and/or process information stored in the memory 730 and/or to store information in the memory 730.

The input component 740 may enable the device 700 to receive input, such as user input and/or sensed input. For example, the input component 740 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 750 may enable the device 700 to provide output, such as via a display, a speaker, and/or a light-emitting diode. The communication component 760 may enable the device 700 to communicate with other devices via a wired connection and/or a wireless connection. For example, the communication component 760 may include a receiver, a transmitter, a transceiver, a modem, a network interface card, and/or an antenna.

The device 700 may perform one or more operations or processes described herein. For example, a non-transitory computer-readable medium (e.g., memory 730) may store a set of instructions (e.g., one or more instructions or code) for execution by the processor 720. The processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry may be used instead of or in combination with the instructions to perform one or more operations or processes described herein. Additionally, or alternatively, the processor 720 may be configured to perform one or more operations or processes described herein. Thus, implementations described herein are not limited to any specific combination of hardware circuitry and software.

The number and arrangement of components shown in FIG. 7 are provided as an example. The device 700 may include additional components, fewer components, different components, or differently arranged components than those shown in FIG. 7. Additionally, or alternatively, a set of components (e.g., one or more components) of the device 700 may perform one or more functions described as being performed by another set of components of the device 700.

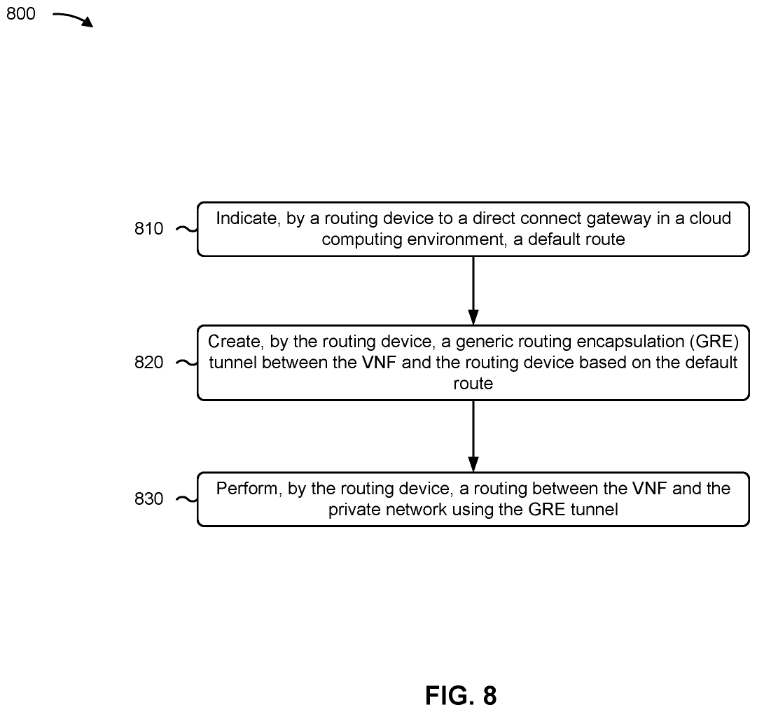

FIG. 8 is a flowchart of an example process 800 associated with creating tunnels for routing in a cloud computing system. In some implementations, one or more process blocks of FIG. 8 may be performed by a routing device (e.g., router 110). In some implementations, one or more process blocks of FIG. 8 may be performed by another device or a group of devices separate from or including the routing device. Additionally, or alternatively, one or more process blocks of FIG. 8 may be performed by one or more components of device 700, such as processor 720, memory 730, input component 740, output component 750, and/or communication component 760.

As shown in FIG. 8, process 800 may include indicating, by the routing device to a direct connect gateway in a cloud computing system, a default route (block 810). The default route may be propagated to a VNF running in the cloud computing system. The VNF may be associated with a firewall, a session border controller, an SD-WAN, routing, a secure gateway, or a VPN concentrator. The routing device may be a MPLS PE router.

As further shown in FIG. 8, process 800 may include creating a GRE tunnel between the VNF and the routing device based on the default route (block 820). The GRE tunnel may permit a direct peering between the VNF and a private network outside of the cloud computing system. The private network may be an MPLS network. A plurality of routes may be advertised to the VNF via the GRE tunnel, where a quantity associated with the plurality of routes may be greater than a routing limit associated with the direct connect gateway based on only the default route being apparent to the cloud computing system.

As further shown in FIG. 8, process 800 may include performing a routing between the VNF and the private network using the GRE tunnel (block 830). An infrastructure in the cloud computing system may be transparent during the routing, where the infrastructure may include a virtual private gateway, a direct connect gateway, and/or an Internet gateway. The routing device may add a route to a list of advertised routes using a data routing protocol, such as a dynamic BGP, where the route may be added to the list based on an availability of the VNF. The routing device may remove a route from the list of advertised routes using the dynamic BGP, where the route may be removed from the list based on an unavailability of the VNF.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
indicating, by a routing device to a direct connect gateway in a cloud computing system, a default route, wherein the default route is propagated to a virtual network function (VNF) running in the cloud computing system;
creating, by the routing device, a generic routing encapsulation (GRE) tunnel between the VNF and the routing device based on the default route, wherein the GRE tunnel permits a direct peering between the VNF and a private network outside of the cloud computing system; and
performing, by the routing device, a routing between the VNF and the private network using the GRE tunnel.

2. The method of claim 1, further comprising:
adding, by the routing device, a route to a list of advertised routes using a data routing protocol, wherein the route is added to the list based on an availability of the VNF.

3. The method of claim 1, further comprising:
removing, by the routing device, a route from a list of advertised routes using a dynamic border gateway protocol (BGP), wherein the route is removed from the list based on an unavailability of the VNF.

4. The method of claim 1, wherein an infrastructure in the cloud computing system is bypassed during the routing, wherein the infrastructure includes one or more of: a virtual private gateway, a direct connect gateway, or an Internet gateway.

5. The method of claim 1, further comprising:
advertising a plurality of routes to the VNF via the GRE tunnel, and wherein a quantity associated with the plurality of routes is greater than a routing limit associated with the direct connect gateway based on only the default route being apparent to the cloud computing system.

6. The method of claim 1, wherein the VNF is associated with a firewall, a session border controller, a software-defined wide area network (SD-WAN), routing, a secure gateway, or a virtual private network (VPN) concentrator.

7. The method of claim 1, wherein the private network is a multi-protocol label switching (MPLS) network.

8. The method of claim 7, wherein the routing device is a private Internet Protocol MPLS provider edge (PE) router.

9. A device, comprising:
one or more processors configured to:
transmit, to a direct connect gateway in a cloud computing system, an indication of a default route, wherein the default route is propagated to a virtual network function (VNF) running in the cloud computing system;
create a generic routing encapsulation (GRE) tunnel to the VNF based on the default route, wherein the GRE tunnel permits a direct peering between the VNF and a private network outside of the cloud computing system; and
use the GRE tunnel to perform routing between the VNF and the private network.

10. The device of claim 9, wherein the one or more processors are further configured to:
add a route to a list of advertised routes using a dynamic border gateway protocol (BGP), wherein the route is added to the list based on an availability of the VNF.

11. The device of claim 9, wherein the one or more processors are further configured to:
remove a route from a list of advertised routes using a dynamic border gateway protocol (BGP), wherein the route is removed from the list based on an unavailability of the VNF.

12. The device of claim 9, wherein an infrastructure in the cloud computing system is transparent during the routing, wherein the infrastructure includes one or more of: a virtual private gateway, a direct connect gateway, or an Internet gateway.

13. The device of claim 9, wherein a plurality of routes are advertised to the VNF via the GRE tunnel, and wherein a quantity associated with the plurality of routes is greater than a routing limit associated with the direct connect gateway based on only the default route being apparent to the cloud computing system.

14. The device of claim 9, wherein the VNF is associated with a firewall, a session border controller, a software-defined wide area network (SD-WAN), routing, a secure gateway, or a virtual private network (VPN) concentrator.

15. The device of claim 9, wherein the private network is a multi-protocol label switching (MPLS) network.

16. The device of claim 15, wherein the device is a private Internet Protocol MPLS provider edge (PE) router.

17. A non-transitory computer-readable medium storing a set of instructions, the set of instructions comprising:
one or more instructions that, when executed by one or more processors of a device, cause the device to:
indicate, to a direct connect gateway in a cloud computing system, a default route, wherein the default route is propagated to a virtual network function (VNF) running in the cloud computing system;
create a generic routing encapsulation (GRE) tunnel to the VNF based on the default route, wherein the GRE tunnel permits a direct peering between the VNF and a private network outside of the cloud computing system; and
perform a routing between the VNF and the private network using the GRE tunnel.

18. The non-transitory computer-readable medium of claim 17, wherein the one or more instructions, when executed by the one or more processors, further cause the device to:
add a route to a list of advertised routes using a dynamic border gateway protocol (BGP), wherein the route is added to the list based on an availability of the VNF; or
remove the route from the list of advertised routes using the dynamic BGP, wherein the route is removed from the list based on an unavailability of the VNF.

19. The non-transitory computer-readable medium of claim 17, wherein an infrastructure in the cloud computing system is transparent during the routing, wherein the infrastructure includes one or more of: a virtual private gateway, a direct connect gateway, or an Internet gateway.

20. The non-transitory computer-readable medium of claim 17, wherein a plurality of routes are advertised to the VNF via the GRE tunnel, and wherein a quantity associated with the plurality of routes is greater than a routing limit associated with the direct connect gateway based on only the default route being apparent to the cloud computing system.
